(19) United States
(12) Patent Application Publication
(10) Pub. No.: US 2026/0093751 A1
(43) Pub. Date: Apr. 2, 2026

(54) Techniques for Importing Media Libraries

(71) Applicant: Apple Inc., Cupertino, CA (US)

(72) Inventors: Shachi Khare, San Jose, CA (US); Nicholas A. Tucey, Los Gatos, CA (US); Sebastien P. Sahuc, Piedmont, CA (US); Daniel Chu, Hacienda Heights, CA (US); Ying Chen, Cupertino, CA (US); Betim Deva, Mountain View, CA (US); Mashu Takeda, Seattle, WA (US); Santosh Shankar, Santa Clara, CA (US); Bryan R. Donovan, Portland, OR (US); Harshil M. Gandhi, Santa Clara, CA (US); Ashok U. Mallya, Campbell, CA (US); Vidhyaa Muralidharan, Sunnyvale, CA (US); Dung T. Le, Seattle, WA (US); Nicholas M. Sankoe, San Jose, CA (US)

(21) Appl. No.: 19/034,486

(22) Filed: Jan. 22, 2025

Related U.S. Application Data
(60) Provisional application No. 63/700,530, filed on Sep. 27, 2024.

(51) Int. Cl. G06F 16/483; G06F 16/432

(52) U.S. Cl. CPC G06F 16/483; G06F 16/432

(57) ABSTRACT

Generating a media library at a requesting media service is performed using media metadata describing target media items. The process involves receiving media metadata corresponding to various media items, performing a matching process to identify candidate media items on the requesting service, and adding the matched media items to the user's media library on the requesting service. The matching process involves determining similarity scores between the metadata and a candidate media item based on characteristics described in the metadata. The technique allows a user to manually select among candidate media items if a match is not found.

### FIELD OF THE INVENTION

This disclosure relates generally to media management and more specifically to providing a system and method for transferring media libraries across media services.

### BACKGROUND

Platforms for distributing media have transformed the way users access music and other types of media. These platforms collaborate with various music distributors and host music, music videos, concert films, podcasts, audio books, movies, television series, and the like on their platform. In addition, some platforms allow users to upload their own music to their own library, thereby allowing for the seamless access to user-owned media, subscription content, or other content on media platforms through digital distribution services.

While they all achieve similar results, their features can differ vastly. Accordingly, it may be preferable to use different platforms for different features. Thus, what is needed is a tool to transfer media items across different platforms to provide users more options and features for enjoying their media.

### BRIEF DESCRIPTION OF THE DRAWINGS

FIG. 1 shows, in block diagram form, a simplified network diagram according to one or more embodiments.

FIG. 2 shows, in flowchart form, an example method for building a media library based on media items at a remote media service, according to one or more embodiments.

FIG. 3 shows, flowchart form, an example method for identifying matching media items across media services, in accordance with one or more embodiments.

FIG. 4 shows, in flowchart form, an example method for recreating a playlist at a destination media service, in accordance with one or more embodiments.

FIG. 5 shows an example flow diagram for using a transfer service to build a media library, according to one or more embodiments.

FIG. 6 shows an example flow diagram of a state machine for determining session states, in accordance with one or more embodiments.

FIG. 7 shows an example system diagram for an electronic device in accordance with one or more embodiments.

### DETAILED DESCRIPTION

This disclosure is directed to systems, methods, and computer readable media for providing a media library transfer system. The process involves receiving media metadata corresponding to various media items, performing a matching process to identify candidate media items on the requesting service, and adding the matched media items to the user's media library on the requesting service.

According to one or more embodiments, techniques described herein are directed to receiving and extracting metadata that encodes characteristics of one or more media items from a source media platform. The techniques described herein can analyze the metadata to extract information such as titles, artists, albums, and durations. With respect to playlists, the metadata may be used to extract playlist names, ordering on the playlist, and the like. Using the fields extracted from the metadata, the system can generate search queries for a target media platform, leading to a more reliable discovery of equivalent media items on the destination service.

Upon receiving candidate media items from the destination service, a matching algorithm can be applied to determine a best match. The matching algorithm may assign similarity scores to potential media matches. The candidate media items can then be ranked according to the similarity scores, and a best match can be selected. In some embodiments, if no best match is found, the candidate media items may be presented to a user for manual selection of the best match.

Techniques described herein provide a technical improvement to digital media transfer because rather than porting entire media items, metadata representing the media items can be used to identify matching media items at a local device. This significantly reduces the bandwidth required to port media libraries. Further, by relying on metadata encoding characteristics of the media items, a user's library can be transferred without exposing personal or identifying information.

In the following description, for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed embodiments. In this context, it should be understood that references to numbered drawing elements without associated identifiers (e.g., 100) refer to all instances of the drawing element with identifiers (e.g., 100a and 100b). Further, as part of this description, some of this disclosure's drawings may be provided in the form of a flow diagram. The boxes in any particular flowchart may be presented in a particular order. However, it should be understood that the particular flow of any flow diagram is used only to exemplify one embodiment. In other embodiments, any of the various components depicted in the flowchart may be deleted, or the components may be performed in a different order, or even concurrently. In addition, other embodiments may include additional steps not depicted as part of the flowchart. The language used in this disclosure has been principally selected for readability and instructional purposes, and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

It should be appreciated that in the development of any actual implementation (as in any development project), numerous decisions must be made to achieve the developers'specific goals (e.g., compliance with system and business-related constraints), and that these goals will vary from one implementation to another. It will also be appreciated that such development efforts might be complex and time consuming, but would nevertheless be a routine undertaking for those of ordinary skill in the art of image capture having the benefit of this disclosure.

For purposes of this disclosure, the term “media item” refers to a digital media item hosted or provided by a media platform. Media items could be any kind of media item, such as audio media items, video media items, visual media items, textual media items, podcasts, interviews, songs, audio books, and the like.

For purposes of this disclosure, the term “playlist” refers to a collection of media items which may be associated with a particular order. Examples include song playlists, episodic media such as podcasts, or other sets of media items.

### Example Network Diagram

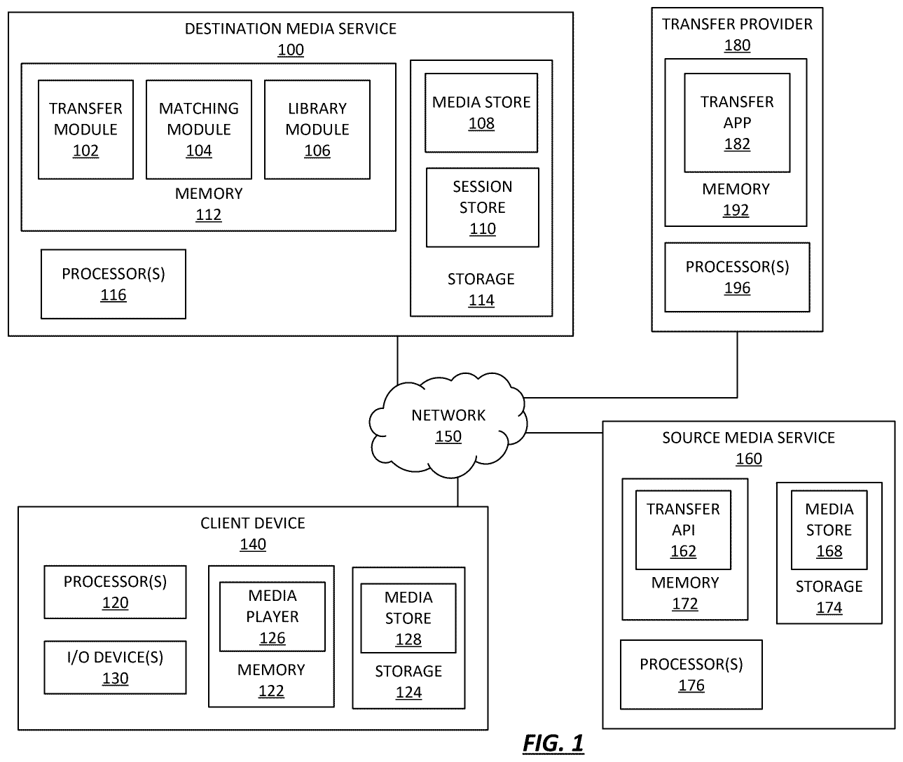

Embodiments described herein are directed to a technique for generating or populating a media library on a destination media platform based on metadata characterizing media items from a remote source. Referring to FIG. 1, a simplified block diagram is depicted of a destination media service 100 connected to a client device 140, for example over a network 150. Client device 140 may be a multifunctional device, such as a mobile phone, tablet computer, personal digital assistant, portable music/video player, wearable device, or any other electronic device that includes a media playback system.

Destination media service 100 may include one or more servers or other computing or storage devices on which the various modules and storage devices may be contained. Although destination media service 100 is depicted as comprising various components in an exemplary manner, in one or more embodiments, the various components and functionality may be distributed across multiple network devices, such as servers, network storage, and the like. Further, additional components may be used, some combination of the functionality of any of the components may be combined.

Generally, destination media service 100 may include one or more memory devices 112, one or more storage devices 114, and one or more processors 116, such as a central processing unit (CPU) or a graphical processing unit (GPU). Further processor 116 may include multiple processors of the same or different type. Memory 112 may each include one or more different types of memory, which may be used for performing device functions in conjunction with processor 116. For example, memory 112 may include cache, ROM, and/or RAM. Memory 112 may store various programming modules during execution, including transfer module 102, matching module 104, and library module 106.

Destination media service 100 may store media files, media file data, music catalog data, information regarding, for example, songs, albums, artists and creators, publishers, or the like. Additional data may include, but is not limited to, metadata describing the media items or collection of media items such as playlists, data used to generate or transfer media items, and the like. Destination media service 100 may store this data in a media store 108 within storage 114. Storage 114 may include one or more physical storage devices. The physical storage devices may be located within a single location, or may be distributed across multiple locations, such as multiple servers. In some embodiments, storage 114 may also include session store 110. Session store 110 may include data used to populate a library with media items from a source media service 160. For example, session store 110 may include data for state machines used to identify matched media items and populate a library.

Returning to the destination media service 100, the memory 112 includes modules that include computer readable code executable by processor 116 to cause the destination media service 100 to perform various tasks. As depicted, the memory 112 may include a transfer module 102, matching module 104 and library module 106. According to one or more embodiments, the transfer module 102 may be used to interact with transfer provider 180, for example across network 150. In some embodiments, the transfer module 102 may include a transfer service which is configured to manage the overall transfer of the media library and may initiate and manage transfer sessions, including generating and storing session data in session store 110. Transfer module 102 may also include an API which provides an interface between destination media service 100 and a transfer provider 180. According to some embodiments, transfer module 102 is configured to request media library information hosted by source media service 160 from transfer provider 180. In some embodiments, transfer module 102 may receive library data from transfer provider 180, from which a corresponding library can be generated at the destination media service 100. Matching module 104 may be configured to perform a matching process using the library data to identify, based on the library data, matching media items from media hosted by the source media service 160, for example in media store 168. Memory 112 also includes library module 106. Library module 106 may be configured to import matched media items hosted by destination media service 100, for example in media store 108, into a user media library. In some embodiments, library module 106 may additionally manage importing of collections of songs, such as in albums or playlists.

Source media service 160 may be configured to host media items, and user-specific libraries. In some embodiments, source media service 160 may include some similar components to destination media service 100. For example, source media service may include one or more memory devices 172 which may host a transfer API 162. Transfer API 162 may be used to interact with transfer provider 180, for example across network 150 to provide library metadata for destination media service 100 on behalf of client device 140. Transfer API 162 may be configured to generate or obtain media metadata from media store 168 in storage 174. Transfer API 162 may include computer readable code executable by one or more processor(s) 176.

Client device 140 may similarly include one or more memory devices 122, one or more storage devices 124, and one or more processors 120, such as a central processing unit (CPU) or a graphical processing unit (GPU). Further processor 120 may include multiple processors of the same or different type. Memory 122 may each include one or more different types of memory, which may be used for performing device functions in conjunction with processor 120. For example, memory 122 may include cache, ROM, and/or RAM. Memory 122 may store various programming modules such as a media player 126. In some embodiments, media player 126 may be configured to receive and play media items hosted by media services, such as destination media service 100 and source media service 160. In some cases, media player 126 may additionally be configured to play locally stored media such as media items from media store 128 in storage 124. The media items may be played, for example, via I/O device(s) 130, which may include displays, speakers, and the like. According to some embodiments, client device 140 may request for a media library at destination media service 100 to be populated based on the media library hosted by source media service 160. For example, a user associated with client device 140 may have a user account with source media service 160 and destination media service 100. In some embodiments, client device 140 may transmit the request to transfer provider 180 over network 150.

According to one or more embodiments, transfer provider 180 is configured to facilitate a transfer session by fetching the user's music library metadata from a source media service 160 and providing the music library metadata to a destination media service 100 to allow the destination media service 100 to identify matching media items. Further, transfer provider 180 may interface with client device 140 to provide status information regarding a library transfer, for example either within a user interface of media player 126, or within a user interface of a separate application executing on client device 140.

Transfer provider 180 may include one or more memory devices 192, and one or more processors 196, such as a central processing unit (CPU) or a graphical processing unit (GPU). Further processor 196 may include multiple processors of the same or different type. Memory 192 may each include one or more different types of memory, which may be used for performing device functions in conjunction with processor 196. For example, memory 192 may include cache, ROM, and/or RAM. Memory 192 may store various programming modules such as a transfer application 182. According to one or more embodiments, transfer application 182 may be configured to fetch library data from a source media service 160 for a requesting user account. In some embodiments, transfer app 182 may then package the library data into a protocol usable by the destination media service 100. For example, the transfer provider 180 may repackage the metadata into a predefined format expected by destination media service 100. In particular, transfer application 182 may be configured to provide an initiation signal to the destination media service 100 indicating that a metadata payload is being transmitted and an expected size of the payload. In some embodiments, the initial signal may indicate expected counts of different types of media items for which metadata is to be provided, sch as albums, songs, music videos, playlists, and the like. Upon completion of the transfer of metadata to the destination media service 100, the transfer application 182 may send a finalized signal to indicate that the transfer session is complete. In some embodiments, the finalized signal may include actual count totals for each of the media items for which metadata was actually provided.

### Media Transfer Overview

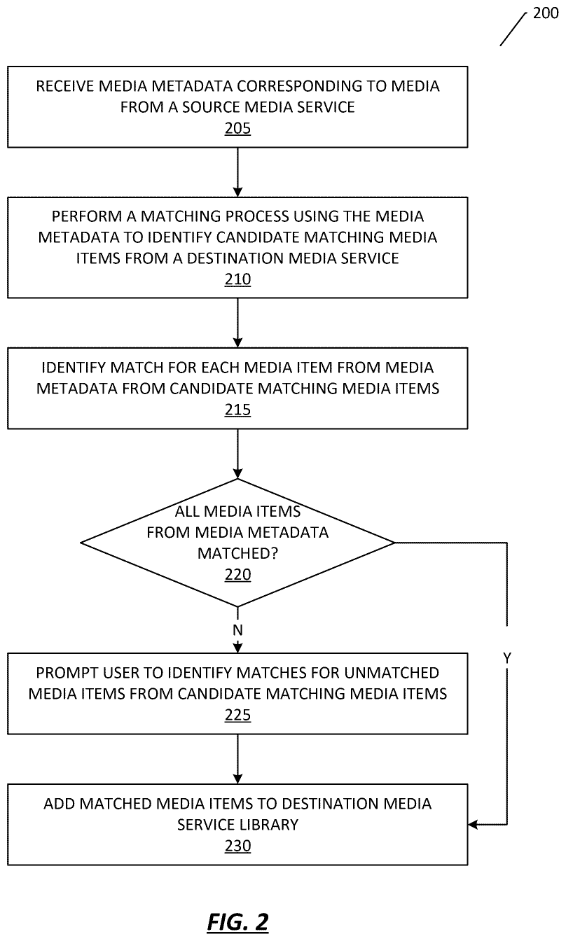

FIG. 2 shows, in flowchart form, an example method for building a media library based on media items at a remote media service, according to one or more embodiments. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added.

The flowchart 200 begins at block 205, where media metadata is received which corresponds to characteristics of media items in a user's media library at a source media service. According to one or more embodiments, the destination media service 100 may receive media metadata for a user's media items at a source media service 160, and use the metadata to identify corresponding media items at the destination media service 100. The metadata received by the destination media service 100 may include characteristics of media items to be populated in the user's library. The media items may include, for example, audio media items, video media items, visual media items, textual media items, podcasts, interviews, songs, audio books, and the like. Examples of characteristics that may be included in different metadata categories, for example, song identifier, International Standard Recording Code (“ISRC”), Universal Product Code (“UPC”), media item name, artist(s) name(s), artwork identifier, duration, content rating, release date, album name, and the like.

Further, the media items may include predefined collections of media items, such as music albums, serialized podcasts, and the like. Metadata categories for albums may include, for example, album identifier, album UPS, album name, artist(s) name(s), artwork identifier, duration, content rating, release date, track count, and the like.

The media items may also include user-defined collections of media items, such as user-generated playlists. The predefined or user-defined collections may include a particular order for the media items, which may be included in the metadata. Metadata categories for playlists may include, for example, playlist identifier, playlist name, playlist description, artwork identifier, and track count.

The flowchart 200 proceeds to block 210, where a matching process is performed using the media metadata to identify candidate matching media items from a destination media service. Said another way, the destination media service 100 may utilize the received metadata, for example from transfer provider 180, to identify matching media items hosted on the destination media service 100. The matching process can be performed in a variety of ways. For example, a search may be performed among media items hosted by the destination media service 100 based on the metadata. As another example, one or more identifiers for the media item may be used to identify the corresponding media item from the destination media service 100.

At block 215, matches are identified for each of the media items based on the media metadata and from the candidate matching media items from block 210. For example, for a particular media item, a set of candidate media items may be identified. A refinement process may be applied to identify a best match for a particular media item. The refinement process may include, for example, determining a confidence value that each candidate media item is a best match, or a match value indicating how strong the match is. The confidence value may be based on how similar different categories of metadata are for the particular media item and each of the candidate media items. In some embodiments, the refinement process may include weighting the categories differently, and different weights may be used for different types of media items. For example, for song media items, song name, artist name, and album name, may be weighted more heavily than other metadata categories, such as a description or duration. Alternatively, for album, duration name, and artist may be weighted more heavily than track count, release date, or the like. From the match values or confidence values, a best match can be determined among the candidate media items. According to one or more embodiments, a threshold value, such as a minimum match value or confidence value, must be satisfied in order for a best match to be identified. Thus, in some embodiments, the matching process may result in not finding a match for some media items.

The flowchart 200 proceeds to block 220, where a determination is made as to whether all media items from the media metadata payload are matched. If a determination that not all media items are matched, then the flowchart 200 proceeds to block 225, and a user is prompted to manually select a best match among the candidate matches for the unmatched media items. In some embodiments, the user prompt will be presented at a user device, for example as part of a media player associated with the destination media service 100, or within a user interface for a separate application. The user may be presented with unmatched media items and a plurality of candidate media items identified from block 210. In some embodiments, the user may be presented with an option to skip a particular media item if a best match is not found among the candidate media items.

After these are selects the matches for the unmatched media items, or, returning to block 220, if all the medium items were automatically matched, then the flowchart concludes at block 230. At block 230, the matched media items are added to a destination media service library. According to the embodiments, adding the matched media items to the destination media service library may include populating a user's media library with the media items such that the user can access the media items from within the destination media service library. In some embodiments, adding matched media items to the destination media service library may additionally include adding collections of media items, such as user-defined playlist. Accordingly, adding matched media items to the destination media service may include generating user-generated playlists or other collections to mirror the user-generated playlist or other media collections identified in the media metadata.

### Media Matching Process

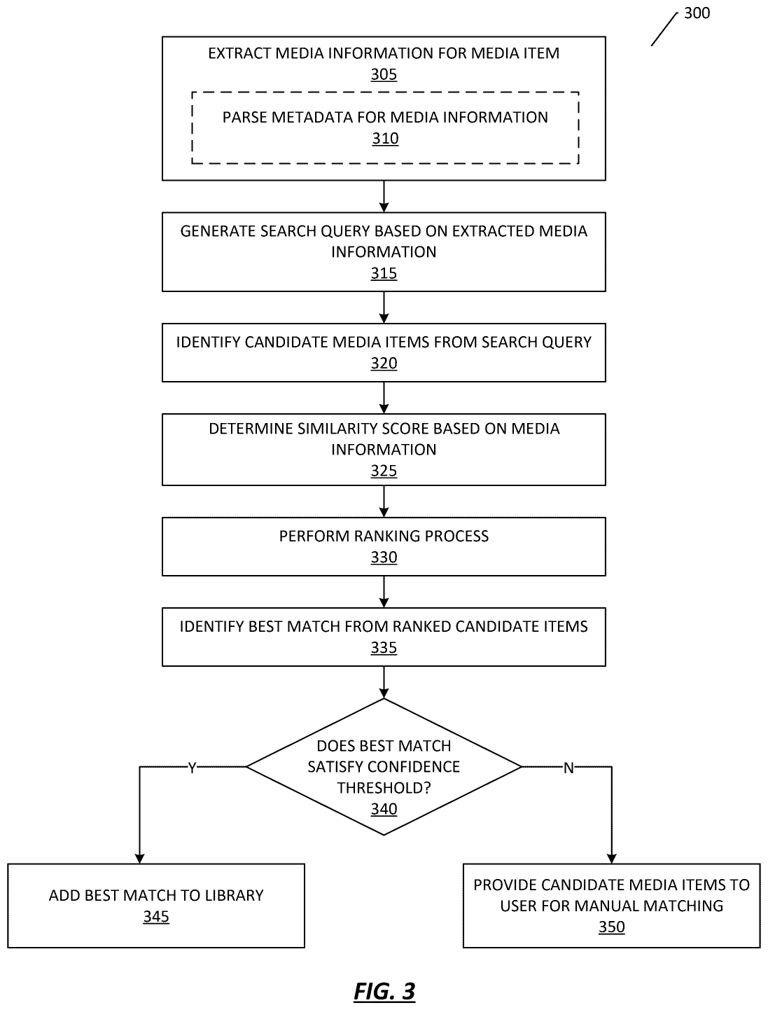

From the media metadata, the destination media service 100 can extract individual values which are used for performing the matching process. The matching process may be a multi-step process involving different match states, and may be performed automatically, but may be flexible enough to enable partially manual user matching to improve match quality. FIG. 3 shows, flowchart form, an example method for identifying matching media items across media services, in accordance with one or more embodiments. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added.

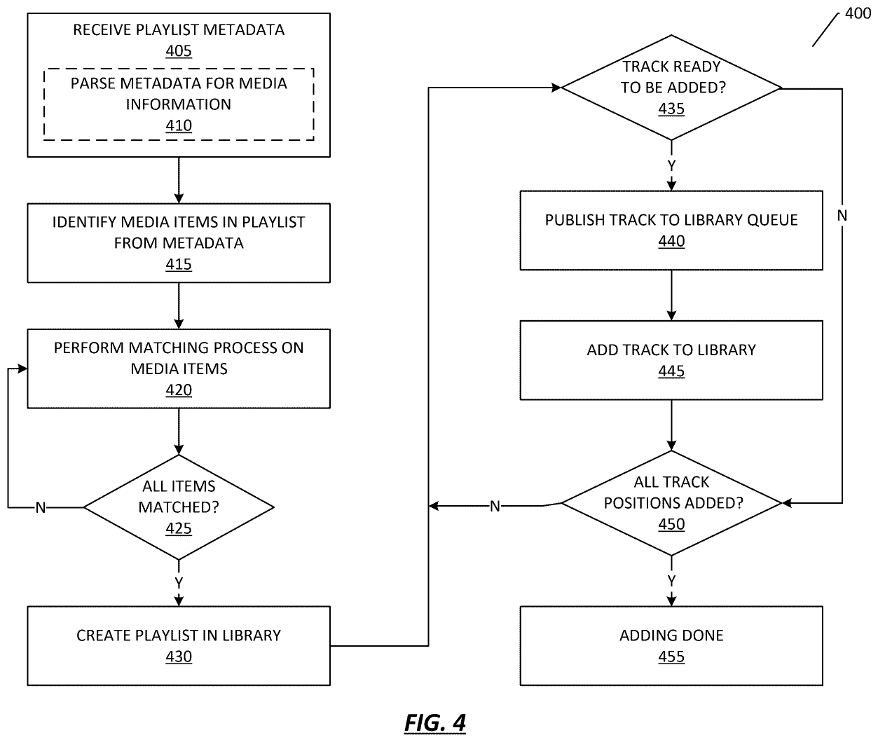

The flowchart 300 begins at block 305, where media information is extracted from the media metadata for a particular media item. As described above, the media metadata may describe different types of media items, such as songs, interviews, podcasts, audio books, music videos, video media items, and the like, as well as predefined and user-generated collections of media items, such as albums, media series, user-generated playlists, media collections, and the like, which may or may not be serialized or otherwise provided or generated in a specific order. The metadata may be received in a payload that includes an initial transmission indicating an amount of metadata to be expected, such as a count of media items or a count for each type of media item. In some embodiments, the metadata payload may reduce the media items in the source media library to prevent redundancies. For example, if an album is included in the media metadata common songs from that album may be skipped. By contrast, only complete albums are included such that if the source library only includes some songs from an album, those songs will be imported individually. The metadata payload may initially include information regarding user generated playlists. The metadata for these playlists may include an identifier for the playlist, and a set of metadata for each track of the playlist, including a sequence number for each particular track such that the playlist can be regenerated at the destination media service 100, as will be described in greater detail below with respect to FIG. 4.

In some embodiments, the metadata may not be received in an expected form, such that the individual characteristics of different media items must be parsed to identify the values for different metadata categories, as shown at optional step 310. For example, if the metadata payload does not cleanly distinguish between different categories, a parsing process may be used to detect different categories of metadata. In some embodiments, unstructured text or differently structured text may be provided in the metadata payload which must be parsed to identify different metadata values. In some embodiments, the ordering or format of the unstructured text may be predefined or otherwise know to the destination media service. For example, if a source media service 160 consistently uses a particular order of media item characteristics in the metadata, then the destination media service 100 may receive or have access to the order of media item characteristics, which can then be used to extract metadata values from the unstructured metadata. In some embodiments, the ordering of the values may not be known. Accordingly, a machine learning model or other trained network may be used to predict the categories to which different portions of the unstructured or differently structured metadata belong.

Flowchart 300 proceeds to block 315, where a search query is generated based on the extracted media information. In some embodiments, the search query may be built from one or more of the values for different metadata categories. In some embodiments, additional processing may be performed on the metadata values prior to generating the search query in order to generate sufficient search results. For example, title information from the metadata information that is not consistent among different instances of the same media item. In one example, a title received from one metadata payload may list featured artists in a title, whereas a title received from another metadata payload may omit the feature artists in the title. Thus, to generate the search query, featured artists or other similar signifiers may be omitted for generating the search query. The search query may be designed based on particular indexing of media by the destination media service 100 and may involve using specific keywords, phrases, and logical operators to improve search results.

At block 320, candidate media items for a particular media item are identified from the search query. This may include, for example, submitting the search query to a search index for the destination media service 100. The candidate media items may be retrieved based on the parameters of the query. According to not events, the candidate media items may be retrieved on a per item basis, such as per song, per album, or the like.

In some embodiments, a similarity score may be determined based on the media information, as described at block 325. According to one or more embodiments, the similarity score may be based on a similarity between values of the metadata categories from the received metadata, and corresponding categories for the candidate media items from the destination media service 100. For example, a text similarity score may be determined for such categories as title, artists, and title version, as well as Boolean features for content rating, duration values, ISRC, UPC, and the like. In some embodiments, the same values may be used as were used to generate the search query at block 315. Additionally, or alternatively, in some embodiments alternative data can be used. For example, if a title version was parsed to remove featured artists or the like for purposes of the search query, the full title version maybe used in order to determine similarity. Similarly, if other portions of the metadata were omitted for generating the search query, the omitted metadata may be used for determining similarity. Accordingly, determining similarity may involve a stricter set of parameters than determining candidate media items.

The flowchart 300 proceeds to block 330, where a ranking process is performed. The ranking process may include determining a best match based on the similarity scores determined at block 325. In some embodiments, a model may be trained to predict and/or rank similarity values of candidate media items compared to a particular media item. To that end, the similarity scores and the ranking process may optionally be performed together or in combination. In some embodiments, a ranking model, such as a nonlinear gradient boost decision tree ranking model is used to rank the results based on various features from which similarity was or is determined, such as the text similarity scores for the title, artists, and title version, as well as Boolean features for content rating and duration.

At block 335, the best match is identified from the ranked candidate items. Identifying the best match may include determining which candidate item is most similar to the particular media item for which the search query was generated. In some embodiments, the best match candidate item may be associated with a highest similarity score among the candidate media items, which may indicate a quantitative value for the match, such as a percentage similarity, a confidence value for the match, or the like.

At block 340, a determination is made as to whether the best match satisfies a confidence threshold. In some embodiments, none of the candidate media items retrieved from the search query may be substantially similar as to satisfy a threshold quantitative value in which the particular media item can be automatically matched. Thus, If the determination is made that the best match does satisfy the confidence threshold, then the flowchart 300 concludes at block 345, and the best match is added to the library. In some embodiments, adding the best match to the library may include modifying a media library for the user to include the candidate media item hosted by the destination media service such that the candidate media item becomes available to the user on the destination media service. Further, an indication of the candidate media item may be presented in a user interface associated with a media library for the user, or the like. For example, a reference to a hosted media item corresponding to the best match may be stored in conjunction with the user's profile for the destination media service such that the hosted media item corresponding to the best match is considered part of the user's media library on the destination media service.

Returning to block 340, the determination is made that the best match does not satisfy a confidence threshold, then the flowchart concludes at block 350. At block 350 a user is prompted to select a candidate media item to match the particular media item, for example at a client device 140. The prompt may be received from the destination media service 100, and/or the transfer provider 180. In some embodiments, an indication of two or more potential candidate media items may be presented to the user, along with information from the metadata corresponding to the particular media item being matched. In some embodiments, the two or more potential candidate media items may be selected based on confidence values or match scores for the candidate media items among the set of candidate media items retrieved from the search query. A user-selected match can then be received at the destination media service 100 from among the candidate media items presented to the user. In some embodiments, the user can determine that no good match is provided and may instead select to skip the particular media item from being matched on the destination media service 100.

### Playlist Generation

In some embodiments, a user's library being imported into the destination media service 100 may include personalized collections of media items for which a match needs to be recreated. For example, unlike an album, which includes a collection of media items generally available to users at multiple media services, such as destination media service 100 and source media service 160, a user-generated playlist may have been generated by a user on a particular media service, such as source media service 160 and is not generally available on other media services. Accordingly, a matching playlist will not be identified at the destination media service 100. Instead, the playlist is regenerated from matches to media items comprised in the playlist. FIG. 4 shows, in flowchart form, an example method for recreating a playlist at a destination media service, in accordance with one or more embodiments. For purposes of explanation, the following steps will be described in the context of FIG. 1. However, it should be understood that the various actions may be taken by alternate components. In addition, the various actions may be performed in a different order. Further, some actions may be performed simultaneously, and some may not be required, or others may be added.

The flowchart 400 begins at block 405, where playlist metadata is received. In some embodiments, playlist metadata may include information such as the name of the playlist, a playlist identifier from the source media service, a description of the playlist, artwork information for the playlist, a track count, and the like. For each playlist, playlist track metadata may additionally be received. The playlist track metadata may include a series of datasets for each media item in the playlist. Each data set may include information for the individual track, such as name, media type, ISRC, UPC, source identifier, artist, album, artwork information, duration, content rating, release date, sequence number indicative of a track order of the playlist, and the like. In addition, the data set may include metadata related to a sequence number or other identifier for a position of the media item in the playlist.

In some embodiments, the metadata may not be received in an expected form, such that the individual characteristics of different media items must be parsed to identify the values for different metadata categories, as shown at optional block 410. In some embodiments, unstructured text or differently structured text may be provided in the metadata payload which must be parsed to identify different metadata values. In some embodiments, the ordering or format of the unstructured text may be predefined or otherwise know to the destination media service, or other trained network may be used to predict the categories to which different portions of the unstructured or differently structured metadata belong. At block 415, the different media items are identified from the playlist metadata. Identifying the media items may include parsing the playlist track metadata to identify individual media items belonging to the playlist.

The flowchart 400 proceeds to block 420, where a matching process is performed on each of the media items. The matching process may include generating a search query based on one or more metadata categories for a media item, identifying candidate media items from the destination media service, determining a similarity score based on the metadata values, and ranking the candidate media items based on the similarity score. A best match candidate media item having the highest similarity score among the candidate media items may be selected as a match for the media item. In some embodiments, if a candidate media item can not be sufficiently matched, then a manual process may occur, as described above, where a user is prompted to select a match from among a set or subset of candidate media items. A determination is made at block 425 as to whether all items are matched. If all items are not matched, then the flowchart returns to block 420 and the matching process continues until all items are matched.

Once all items are matched, the flowchart proceeds to block 430, and the playlist is created in the user's media library at the destination media service. The playlist may be created, for example, by generating a playlist reference having matching information such as title and description from the playlist metadata. Further, the playlist may be generated to include a set of tracks which may be associated with a particular order as defined in the playlist metadata.

In some embodiments, the individual tracks for the playlist may be added asynchronously from the creation of the playlist. To that end, the flowchart 400 proceeds to block 435 where a determination is made as to whether the track is ready to be added. A track may be ready to be added, for example, if the track has been matched and/or optionally reviewed by a user. If a track is ready to be added, the flowchart proceeds to block 440, and the track is published to a library queue such that the track is in line to be added to the user's library, for example by library module 106 of destination media service 100. At block 445, the track is added to the library once it reaches the top of the queue.

A determination is made at block 450 as to whether all track positions have been added. In particular, when the playlist is created in the library at block 430, track positions may be identified from the playlist metadata, and prepared to be populated from the matched media items in the source media service 160. If not all track positions have been added, then the flowchart returns to block 435, where determination is made as to whether any tracks are ready to be added. For example, tracks may be simultaneously added to a library queue, while other tracks are being added. Accordingly, the library queue may be empty prior to the playlist being fully populated such that a media item exists in the library for every track position. Thus, the flowchart 400 proceeds from block 435, and additional tracks are added to the library.

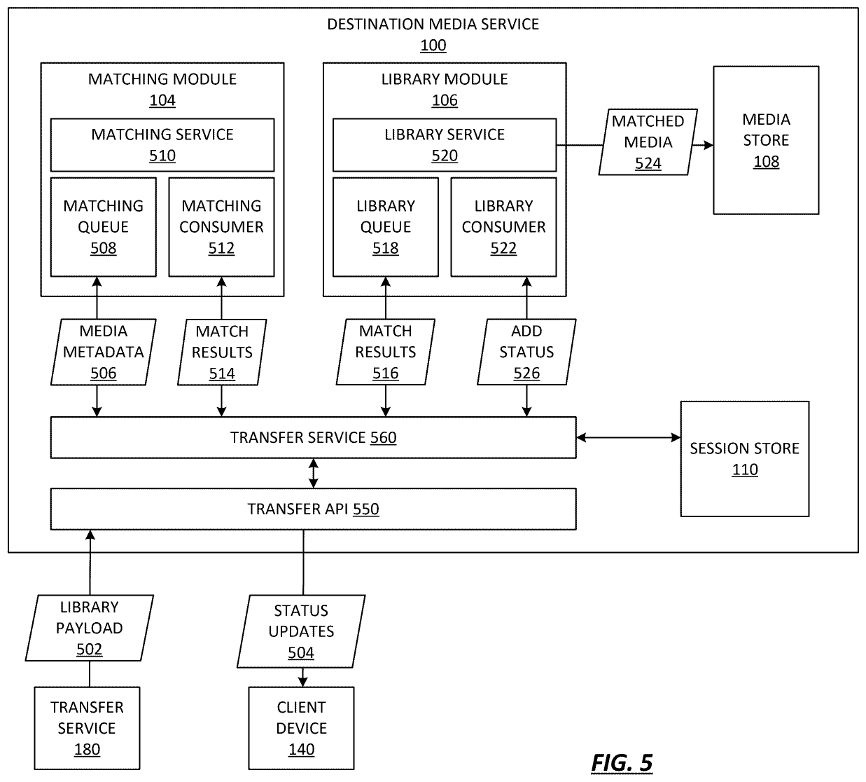

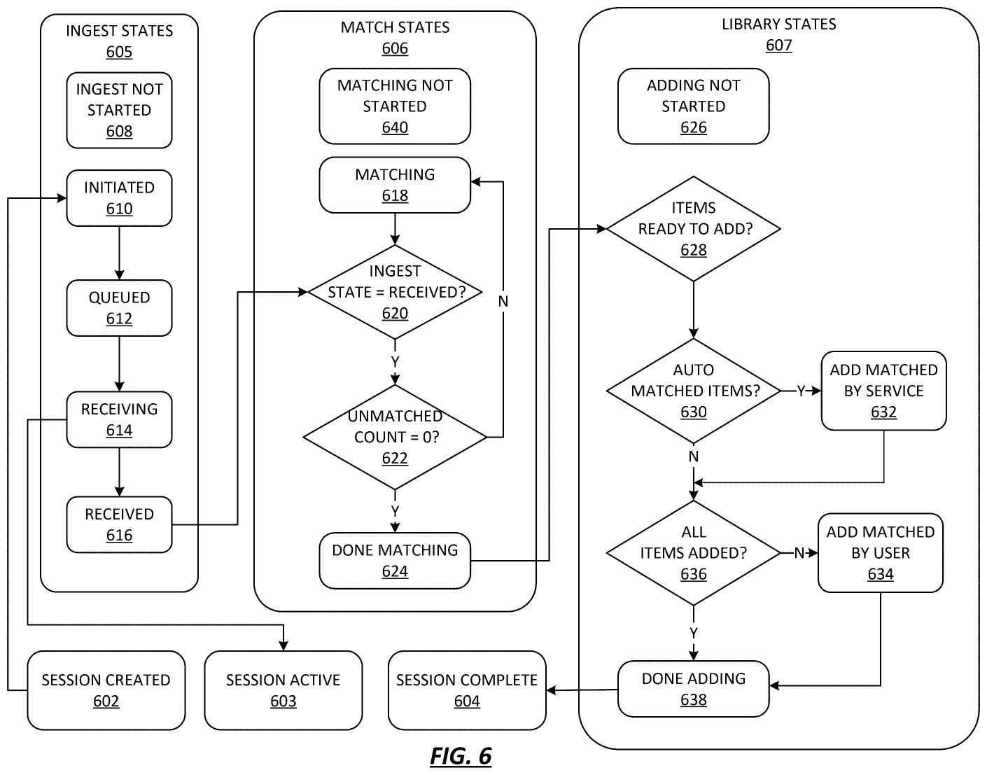

Returning to block 450, if a determination is made that all track positions have been added, then the flowchart concludes at block 455, and the adding is done. As will be described in greater detail below, the determination that adding is done for the playlist may be used as a signal that the process can move onto the next step in importing a user's media library, as will be described in greater detail below with respect to FIGS. 5-6. This may indicate that the library has been created and populated at the destination media service 100.

### Session Data Flow

In order to manage large transfers, several modules may be active in parallel in order to perform various functions required to port a media library. FIG. 5 shows an example flow diagram for using a transfer service to build a media library, according to one or more embodiments. For purposes of this example, reference will be made to the components of FIG. 1. However, it should be understood that additional or alternative components may be used to perform the various processes. Further, the various explanations of data flow are just one example embodiment and alternative data flows may be possible according to embodiments described herein.

The system diagram includes destination media service 100 communicably connected to transfer provider 180 and client device 140. As described above, these are a client device 140 may wish to build a library at destination media service 100 based on a media library at an alternative media service. That alternative media service may interface with transfer provider 180 to provide descriptive metadata for the media items in the media library, from which destination media service 100 can generate a matching version of the media library at destination media service 100.

Example data flow shown in FIG. 5, the process begins with the transfer provider 180 providing a library payload 502 in the form of media metadata. According to one or more embodiments, the library payload 502 may include the media metadata as a payload that includes an initial transmission indicating an amount of metadata to be expected, such as a count of media items or a count for each type of media item. The initial transmission may alert the destination media service 100 that a transfer session is beginning. The library payload additionally and cleared media metadata for different types of media items, such as songs, albums, playlists, while his tracks, and the like. Other examples include music videos, podcasts, interviews, video series, and the like. The metadata for each media item includes identifying information for that media item, such as title, artist, album, duration, content rating, release date, playlist name, playlist description, artwork identifier, track count, and the like. In some embodiments, the library payload may end with a final transmission indicating that the transfer provider 180 has ceased sending the library payload. In some embodiments, the final transition may include the actual count totals for each media item.

The destination media service 100 accepts the library payload 502 using transfer API 550. Transfer API 550 maybe an interface configured to interact with transfer provider 180 and/or client device 140. For example, transfer API 550 may provide functionality by which the transfer request can be received from client device 140, and a library payload 502 can be accepted. Once the library payload 502 begins to be received, the destination media service 100 can begin a matching process. At the same time, the transfer API 550 may provide status updates 504 to client device 140. For example, status updates 504 may indicate how many a library items have been processed, the status of the transfer process, an estimated time remaining, and the like. The status updates 504 may thereafter be presented in an interface in a media player executing on client device 140, or one or more additional applications on client device 140.

The transfer API 550 may interface with a transfer service 560 within destination media service 100. According to events, transfer service 560 may coordinate different processes with a name transfer process. In addition, transfer service 560 may manage session store 110, which is used to manage data used to orchestrate the transfer, such as incoming library payload 502, queues, states from various state machines, match results, and the like.

According to one or more embodiments, transfer service 560 may provide metadata from library of payload 502 to matching module 104 in the form of media metadata 506. In some embodiments, transfer service 560 may parse the library payload 502 to obtain metadata for individual media items prior to providing the media metadata 506 to matching module 104. In some embodiments, transfer service 560 made perform additional processing on the library payload 502, for example, if the metadata is in an unstructured or an unexpected format. In this case, transfer service 560 may parse the library payload 502 to prepare the metadata for matching.

According to one or more embodiments, the matching module 104 may place incoming media metadata 506 in a matching queue 508, which may be part of matching module 104, and/or which may be hosted by session store 110. The matching queue 508 may include items which are ready to be matched. A matching consumer 512 may be tasked with obtaining media metadata from the matching queue 508 to perform the matching process. In some embodiments, the matching process may be performed by matching service 510. As described above, the matching process may involve extracting media information from the media metadata 506, generating a search query for the destination media service 100, for example from media store 108, identifying candidate media items from the search results, and determining a similarity score for each candidate media item based on the media information. A best match may be selected from the candidate media items for each queued media item based on the similarity score and a ranking process. The matching results 514 may then be provided to transfer service 560. Transfer service 560 may indicate the matched state in session store 110, and/or may store an indicator of the media item and the best match in session store 110.

In some embodiments, transfer service may additionally provide match results 516 to library queue 518 of library module 106, which may be part of matching module 104, and/or which may be hosted by session store 110. The library queue 518 may include items which are ready to be added to a media library. A library consumer 522 may be tasked with obtaining the matched media items from the matching queue 508. In some embodiments, the library service 520 may be tasked with adding the matched media 524 to the media library, such as in media store 108. When the matched media items 524 are added to the media library, the add status 526 may be updated and used for status updates 504.

Due to the complexity of the data, especially with large playlists, a state machine workflow is implemented to coordinate the transfer process. This ensures that all necessary data is in place before starting the transfer and matching process. Accordingly, various process may be performed simultaneously on different media item metadata. For example, as a library payload is being received, matching can begin. Similarly, while some media items are being added to the library, others may be in the matching process. FIG. 6 shows an example flow diagram of a state machine for determining session states, in accordance with one or more embodiments. The various states and data flows in FIG. 6 are merely meant to provide an example implementation. Thus, alternative states and data flows may be used in accordance with some embodiments described herein.

The state machine of FIG. 6 begins when a session is created at 602. The example state machine shown in FIG. 6 includes session states, such as session created 602, session active 603, and session complete 604. Further the example state machine includes ingest states 605, such as ingest not started 608, initiated 610, queued 612, receiving 614, and received 616. The example state machine also includes match states 606. The match states 606 may include, for example, matching not started 626, matching 618, and done matching 624. Finally, the example state machine of FIG. 6 includes library states 607. Library states 607 include adding not started 626, add matched by service 632, add match by user 634, and done adding 638.

Prior to a session beginning, an ingest state may be ingest not started 608. Similarly, match state may be matching not started 640, and library state may be library not started 626. According to one more embodiments, a session may be created, for example, when a destination media source begins receiving a metadata payload. This may cause the ingest state to be initiated 610. The metadata payload may then begin to be added to a queue for processing, causing individual media items or sets of types of media items to be identified. Once queued, the ingest state 605 will transition to a receiving state 614, indicating that the metadata payload is being received. The receiving state causes the session state to transition from session created 602 to session active 603. Further, once the metadata payload has been received, the ingest state transitions to received 616.

When the ingest state is received, the data flow continues to block 620, where a match state is determined. Once the ingest state is received at decision block 620, then the process continues to decision block 622 and a determination is made if an unmatched count is zero. Said another way, a determination is made as to whether all items have been matched, either automatically or by a user. If the unmatched count is not zero, then the match state transitions to matching 618, and the matching process is performed.

In some embodiments, the match state may transition to matching not started 640 to matching 618 once ingested media metadata is ready to be matched, and prior to the ingest state transitioning to received 614. In this case, the match state will remain in matching 618 until the ingest state is received as determined at block 620. Returning to block 622, if a determination is made that the unmatched count is zero, then the match state transitions to done matching 624.

Once items are ready to be added to the library, as determined at decision block 628, then a determination is made at decision block 630 as to whether any auto matched items are ready to be added. Items may be ready to add to the library once they are matched. Alternatively, in some embodiments, the entire payload may be matched prior to adding items to the library. That is, in some embodiments, the match state may trigger the candidate media items to be added to the media library. Auto matched items may be media items matched to incoming metadata which have been automatically identified as a best match without requiring user selection. If auto matched items are ready to be added, then the library state 607 transitions to add matched by service 632, while the matched media items are added to the user's library.

After the matched by service media items are added, or if a determination was made that there were no auto matched media items at decision block 630, then the diagram proceeds to decision block 636 and a determination is made as to whether all items are added. If all items are not added, for example if items are still in the library queue or are still ready to be added, then the library state transitions to add matched by user 634, while the manually matched items are added to the library.

Once the matched by user items are added, or if a determination is made that all items are added at block 636, then the library state transitions to done adding 638. According to some embodiment, once the library state transitions to done adding, the session state may transition to session complete 604.

### Example Multifunctional Device

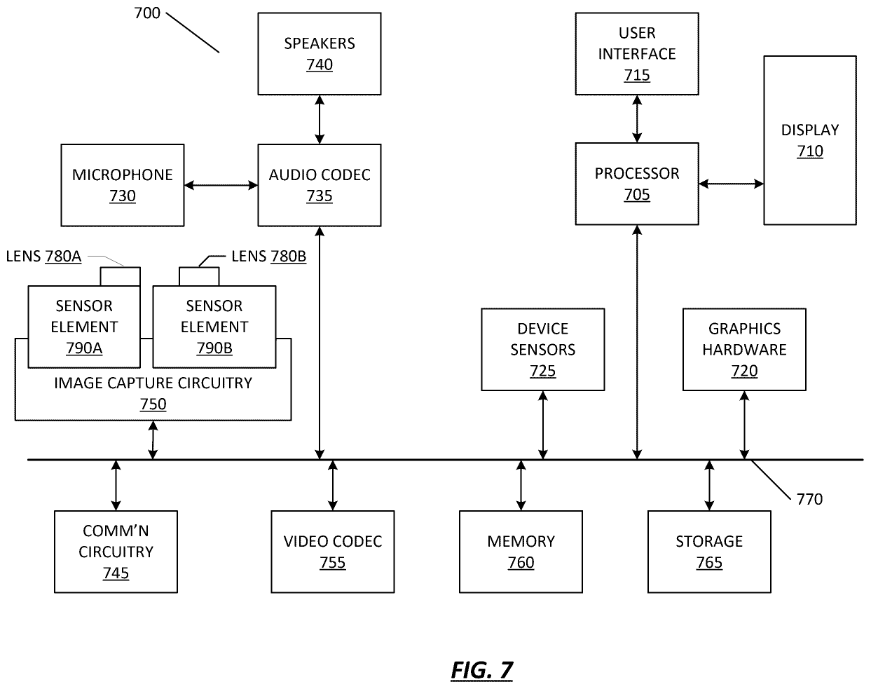

Referring now to FIG. 7, a simplified functional block diagram of illustrative multifunction device 700 is shown according to one embodiment. Multifunctional device 700 may show representative components, for example, for devices of destination media service 100, source media service 160, and client device 140 of FIG. 1. Multifunction electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, digital image capture circuitry 750 (e.g., including camera system) video codec(s) 755 (e.g., in support of digital image capture unit), memory 760, storage device 765, and communications bus 770. Multifunction electronic device 700 may be, for example, a digital camera or a personal electronic device such as a personal digital assistant (PDA), personal music player, mobile telephone, or a tablet computer.

Processor 705 may execute instructions necessary to carry out or control the operation of many functions performed by device 700 (e.g., such as the generation and/or processing of images as disclosed herein). Processor 705 may, for instance, drive display 710 and receive user input from user interface 715. User interface 715 may allow a user to interact with device 700. For example, user interface 715 can take a variety of forms, such as a button, keypad, dial, a click wheel, keyboard, display screen and/or a touch screen. Processor 705 may also, for example, be a system-on-chip such as those found in mobile devices and include a dedicated graphics processing unit (GPU). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 to process graphics information. In one embodiment, graphics hardware 720 may include a programmable GPU.

Image capture circuitry 750 may include two (or more) lens assemblies 780A and 780B, where each lens assembly may have a separate focal length. For example, lens assembly 780A may have a short focal length relative to the focal length of lens assembly 780B. Each lens assembly may have a separate associated sensor element 790A and sensor element 790B. Alternatively, two or more lens assemblies may share a common sensor element. Image capture circuitry 750 may capture still and/or video images. Output from image capture circuitry 750 may be processed, at least in part, by video codec(s) 755 and/or processor 705 and/or graphics hardware 720, and/or a dedicated image processing unit or pipeline incorporated within circuitry 765. Images so captured may be stored in memory 760 and/or storage 765.

Sensor and camera circuitry 750 may capture still and video images that may be processed in accordance with this disclosure, at least in part, by video codec(s) 755 and/or processor 705 and/or graphics hardware 720, and/or a dedicated image processing unit incorporated within circuitry 750. Images so captured may be stored in memory 760 and/or storage 765. Memory 760 may include one or more different types of media used by processor 705 and graphics hardware 720 to perform device functions. For example, memory 760 may include memory cache, read-only memory (ROM), and/or random-access memory (RAM). Storage 765 may store media (e.g., audio, image, and video files), computer program instructions or software, preference information, device profile information, and any other suitable data. Storage 765 may include one more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 760 and storage 765 may be used to tangibly retain computer program instructions or code organized into one or more modules and written in any desired computer programming language. When executed by, for example, processor 705 such computer program code may implement one or more of the methods described herein.

The scope of the disclosed subject matter should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
receiving media metadata encoding characteristics of each of a plurality of media items associated with a first media library for a user on a source media service;
extracting, from the media metadata, media information for a plurality of media information types, for each of the plurality of media items;
performing a matching process to identify a set of candidate media items on a destination media service that match to the plurality of media items on the source media service using the media information for each of the plurality of media information types; and
adding one or more of the set of candidate media items to a second media library for the user on the destination media service.

2. The method of claim 1, wherein the media items comprise at least one selected from a group consisting of songs, albums, videos, and playlists.

3. The method of claim 1, further comprising:
determining a match state for one or more of the plurality of media items; and
triggering the one or more of the set of candidate media items to be added to the second media library in accordance with the match state.

4. The method of claim 1, wherein performing the matching process comprises:
generating a search query for the destination media service using the extracted media information; and
identifying the set of candidate media items from a response to the search query.

5. The method of claim 4, wherein the media information comprises at least one of a group consisting of a title version, a media identifier, artwork identifier, duration, artist, and album.

6. The method of claim 4, further comprising:
determining a similarity score for a particular media item of the plurality of media items with a plurality of corresponding candidate media items;
ranking the corresponding candidate media items based on the similarity score; and
selecting a matching candidate media item based on the rank.

7. The method of claim 1, further comprising:
identifying a first media item of the plurality of media items which remain unmatched after the matching process;
determining one or more media items of the set of candidate media items for the first media item;
presenting an indication of the one or more media items for user selection; and
upon receiving a selection of one of the one or more media items, adding the selected one of the one or more media items to the second media library.

8. The method of claim 1, wherein the media metadata comprises playlist metadata corresponding to a playlist from the source media service,
wherein the playlist metadata comprises metadata for a plurality of media items belonging to the playlist, and
wherein the metadata for each of the plurality of media items comprises a sequence number indicative of a track order of the playlist.

9. A non-transitory computer readable medium comprising computer readable code executable by one or more processors to:
receive media metadata encoding characteristics of each of a plurality of media items associated with a first media library for a user on a source media service;
extract, from the media metadata, media information for a plurality of media information types, for each of the plurality of media items;
perform performing a matching process to identify a set of candidate media items on a destination media service that match to the plurality of media items on the source media service using the media information for each of the plurality of media information types; and
add one or more of the set of candidate media items to a second media library for the user on the destination media service.

10. The non-transitory computer readable medium of claim 9, further comprising computer readable code to:
determine a match state for one or more of the plurality of media items; and
trigger the one or more of the set of candidate media items to be added to the second media library in accordance with the match state.

11. The non-transitory computer readable medium of claim 9, wherein the computer readable code to perform the matching process comprises computer readable code to:
generate a search query for the destination media service using the extracted media information; and
identify the set of candidate media items from a response to the search query.

12. The non-transitory computer readable medium of claim 11, wherein the media information comprises at least one of a group consisting of a title version, a media identifier, artwork identifier, duration, artist, and album.

13. The non-transitory computer readable medium of claim 11, further comprising computer readable code to:
determine a similarity score for a particular media item of the plurality of media items with a plurality of corresponding candidate media items;
rank the corresponding candidate media items based on the similarity score; and
select a matching candidate media item based on the rank.

14. The non-transitory computer readable medium of claim 9, further comprising computer readable code to:
identify a first media item of the plurality of media items which remain unmatched after the matching process;
determine one or more media items of the set of candidate media items for the first media item;
present an indication of the one or more media items for user selection; and
upon receiving a selection of one of the one or more media items, add the selected one of the one or more media items to the second media library.

15. The non-transitory computer readable medium of claim 9, wherein the matching process is performed concurrently with the one or more of the set of candidate media items being added to a second media library.

16. The non-transitory computer readable medium of claim 9, wherein the media metadata comprises playlist metadata corresponding to a playlist from the source media service,
wherein the playlist metadata comprises metadata for a plurality of media items belonging to the playlist, and
wherein the metadata for each of the plurality of media items comprises a sequence number indicative of a track order of the playlist.

17. A system comprising:
one or more processors; and
one or more computer readable media comprising computer readable code executable by one or more processors to:
receive media metadata encoding characteristics of each of a plurality of media items associated with a first media library for a user on a source media service;
extract, from the media metadata, media information for a plurality of media information types, for each of the plurality of media items;
perform performing a matching process to identify a set of candidate media items on a destination media service that match to the plurality of media items on the source media service using the media information for each of the plurality of media information types; and
add one or more of the set of candidate media items to a second media library for the user on the destination media service.

18. The system of claim 17, wherein the media items comprise at least one selected from a group consisting of songs, albums, videos, and playlists.

19. The system of claim 17, further comprising computer readable code to:
determine a match state for one or more of the plurality of media items; and
trigger the one or more of the set of candidate media items to be added to the second media library in accordance with the match state.

20. The system of claim 17, wherein the computer readable code to perform the matching process comprises computer readable code to:
generate a search query for the destination media service using the extracted media information; and
identify the set of candidate media items from a response to the search query.
